(19) United States
(12) Patent Application Publication
(10) Pub. No.: US 2013/0271501 A1
(43) Pub. Date: Oct. 17, 2013

(54) ORGANIC LIGHT EMITTING DIODE DISPLAY AND OPERATING METHOD THEREOF

(71) Applicants: Teng-Chieh Yang, Taipei City (TW); Ming-Ta Hsieh, New Taipei City (TW); Bo-Jhang Sun, Kaohsiung City (TW); Tzu-Pin Lin, Tainan City (TW); Huang-Min Chen, Changhua County (TW)

(72) Inventors: Teng-Chieh Yang, Taipei City (TW); Ming-Ta Hsieh, New Taipei City (TW); Bo-Jhang Sun, Kaohsiung City (TW); Tzu-Pin Lin, Tainan City (TW); Huang-Min Chen, Changhua County (TW)

(73) Assignee: CHUNGHWA PICTURE TUBES, LTD., Taoyuan (TW)

(21) Appl. No.: 13/553,830

(22) Filed: Jul. 20, 2012

(30) Foreign Application Priority Data
Apr. 12, 2012 (TW) 101113025

(51) Int. Cl. G09G 3/32; G09G 5/10

(52) U.S. Cl. 345/690; 345/79

(57) ABSTRACT

An organic light emitting diode (OLED) display and an operating method thereof are provided. The organic light emitting diode display includes an organic light emitting diode display panel and a driving circuit. The organic light emitting diode display panel has a plurality of pixels. The driving circuit is coupled to the organic light emitting display panel and receives a primitive display frame. The driving circuit generates a first frame and a second frame corresponding to the primitive display frame by a polarity inverting means, and outputs a zero gray-level pixel voltage to the corresponding pixels of the organic light emitting diode display panel corresponding to a negative polarity data of the first frame and the second frame, wherein the second frame is adjacent to the first frame.

### CROSS-REFERENCE TO RELATED APPLICATION

This application claims the priority benefit of Taiwan application serial no. 101113025, filed on Apr. 12, 2012. The entirety of the above-mentioned patent application is hereby incorporated by reference herein and made a part of this specification.

### BACKGROUND OF THE INVENTION

1. Field of the Invention

The invention relates to a display and an operating method thereof, and more particularly, to an organic light emitting diode display and an operating method thereof.

2. Description of Related Art

In recent years, the development of flat panel display technology has constantly explored new ways of doing things from old theories, wherein the organic light emitting diode (OLED) displays have the advantages of power-saving, ultra slim, light weight, self light emitting, no view angle limitation, high response speed, high photoelectric efficiency, no need for backlight structure and colour filter structure, high contrast, high luminance efficiency, high brightness, capable of manufacturing multi-color and color (RGB) devices, wide operating temperature range etc., which such displays are regarded as one of the most potential development of flat panel display technology in the future. Therefore, many display manufacturers have invested in the development of organic light emitting diode displays.

Since the driving method of an organic light emitting diode display is different from the liquid crystal display (TFT-LCD), the development of organic light emitting diode displays is required to start from the scratch, thereby the production speed of organic light emitting diode displays is impeded. In addition, the organic light emitting diode display panel is used to encapsulate the organic light emitting diode within a substrate. The organic light emitting diode ages over the usage time, the display effect and the durability of an organic light emitting diode display panel are affected tremendously. Therefore, slowing down the aging process of an organic light emitting diode is an important topic for the design of an organic light emitting diode display.

### SUMMARY OF THE INVENTION

The invention is directed to an organic light emitting display and an operating method thereof, which may slow down the aging process of an organic light emitting diode and extend the durability of an organic light emitting diode.

The invention provides an organic light emitting diode display including an organic light emitting diode display panel and a driving circuit. The organic light emitting diode display panel has a plurality of pixels. The driving circuit is coupled to the organic light emitting display panel and receives a primitive display frame. The driving circuit generates a first frame and a second frame corresponding to the primitive display frame by a polarity inverting means, and outputs a zero gray-level pixel voltage to the corresponding pixels of the organic light emitting diode display panel corresponding to a negative polarity data of the first frame and the second frame, wherein the second frame is adjacent to the first frame.

In an embodiment of the invention, the driving circuit comprises an image segmentation unit, a source driver, and a timing controller. The image segmentation unit receives the primitive display frame and generates the first frame and the second frame by the polarity inverting means, and outputs the adjusted first frame and the adjusted second frame after respectively replacing the negative polarity data of the first frame and the second frame by a zero gray-level data. The source driver is coupled to the organic light emitting diode display panel. The timing controller is coupled to the image segmentation unit and the source driver, and receives the adjusted first frame and the adjusted second frame. The timing controller controls the source driver to output the zero gray-level pixel voltage to the organic light emitting diode display panel corresponding to the zero gray-level data of the adjusted first frame and the adjusted second frame.

In an embodiment of the invention, the driving circuit includes a timing controller, an image replacement unit, and a source driver. The timing controller receives the primitive display frame and generates the first frame and the second frame by the a polarity inverting means. The image replacement unit is coupled to the timing controller and receives the first frame and the second frame, and outputs the adjusted first frame and the adjusted second frame after respectively replacing the negative polarity data of the first frame and the second frame by a zero gray-level data. The source driver is coupled to the timing controller, the image replacement unit and the organic light emitting diode display panel, and receives the adjusted first frame and the adjusted second frame. The source driver is controlled by the timing controller to output the zero gray-level pixel voltage to the organic light emitting diode display panel corresponding to the zero gray-level data of the adjusted first frame and the adjusted second frame.

In an embodiment of the invention, the driving circuit includes a timing controller, a gamma voltage generator, and a source driver. The timing controller receives the primitive display frame and generates the first frame and the second frame by the polarity inverting means. The gamma voltage generator is used to generate a plurality of positive gamma voltages and a plurality of negative gamma voltages, wherein the negative gamma voltages are set as to correspond to the zero gray-level pixel voltage. The source driver is coupled to the timing controller, the gamma voltage generator and the organic light emitting diode display panel. The source driver is controlled by the timing controller and the gamma voltage generator to output the zero gray-level pixel voltage to the organic light emitting diode display panel corresponding to the negative polarity data of the first frame and the second frame.

In an embodiment of the invention, the organic light emitting diode display panel further has a plurality of scan lines and a plurality of data lines, and each of the pixels is coupled to the corresponding scan line and the corresponding data line.

In an embodiment of the invention, the pixels respectively includes a first transistor, a second transistor, a storage capacitor, an organic light emitting diode and a third transistor. The first transistor has a first source, a first drain and a first gate. One of the first source and the first drain is coupled to the corresponding data line, and the first gate is coupled to the corresponding scan line. The second transistor has a second source, a second drain and a second gate. One of the second source and the second drain is coupled to a system voltage, and the second gate is coupled to the other of the first source and the first drain. The storage capacitor is coupled between the second gate and the second source. An anode of the organic light emitting diode is coupled to the other of the second source and the second drain, and a cathode of the organic light emitting diode is coupled to a ground voltage. The third transistor has a third source, a third drain and a third gate. The third source and the third drain are respectively coupled to the anode and the cathode of the organic light emitting diode, the third gate receives a control signal, and when each of the pixels corresponds to the negative polarity data, the third transistor of each of the pixels is turned on.

In an embodiment of the invention, the control signal is a positive pixel voltage or the zero gray-level pixel voltage transmitted by the corresponding data line.

In an embodiment of the invention, the first transistor and the second transistor are P-type transistors, and the third transistor is a N-type transistor.

In an embodiment of the invention, the first transistor and the second transistor are N-type transistors, and the third transistor is a P-type transistor.

In an embodiment of the invention, the first frame and the second frame are complementary in the data polarity.

The invention provides an operating method of an organic light emitting display, which includes the following steps. A primitive display frame is received. A first frame and a second frame corresponding to the primitive display frame are generated by a polarity inverting means, wherein the first frame is adjacent to the second frame. A zero gray-level pixel voltage is outputted to a corresponding part of a plurality of pixels of the organic light emitting diode display panel corresponding to a negative polarity data of the first frame and the second frame.

In an embodiment of the invention, the steps of outputting the zero gray-level pixel voltage to the corresponding part of the pixels of the organic light emitting diode display panel corresponding to the negative polarity data of the first frame and the second frame comprise: outputting the adjusted first frame and the adjusted second frame after respectively replacing the negative polarity data of the first frame and second frame by a zero gray-level data; outputting the zero gray-level pixel voltage to the organic light emitting diode display panel corresponding to the zero gray-level data of the adjusted first frame and the adjusted second frame.

In an embodiment of the invention, the steps of outputting the zero gray-level pixel voltage to the corresponding part of the pixels of the organic light emitting diode display panel corresponding to the negative polarity data of the first frame and the second frame comprise: providing a plurality of positive gamma voltages and a plurality of negative gamma voltages, wherein the negative gamma voltages are set as to correspond to the zero gray-level pixel voltage; outputting the zero gray-level pixel voltage to the organic light emitting diode display panel corresponding to the negative polarity data of the first frame and the second frame according to the negative gamma voltages.

According to the above description, in the organic light emitting display and the operating method thereof in the embodiments of the invention, the driving circuit generates the first frame and the second frame by the polarity inverting means according to the primitive display frame. The driving circuit outputs the zero gray-level pixel voltage to the corresponding pixels of the organic light emitting diode display panel corresponding to the part of the negative polarity data of the first frame and the second frame, and the organic light emitting diode is able to rest, so as to slow down the aging situation.

In order to make the features and advantages of the invention more comprehensible, the invention is further described in detail in the following with reference to the embodiments and the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a system of an organic light emitting diode display according to an embodiment of the invention.

FIG. 1B is a schematic diagram of processing a frame according to an embodiment of the invention.

FIG. 2A is a schematic diagram of a system of a driving circuit according to an embodiment of the invention.

FIG. 2B is a schematic diagram of processing a frame according to an embodiment of the invention.

FIG. 3 is a schematic diagram of a system of a driving circuit according to another embodiment of the invention.

FIG. 4 is a schematic diagram of a system of a driving circuit according to yet another embodiment of the invention.

FIG. 5 is a schematic diagram of a circuit of an organic light emitting diode display panel according to an embodiment of the invention.

FIG. 6 is a schematic diagram of a circuit of an organic light emitting diode display panel according to another embodiment of the invention.

FIG. 7 is a flow diagram of an operating method of an organic light emitting diode display according to an embodiment of the invention.

### DESCRIPTION OF THE EMBODIMENTS

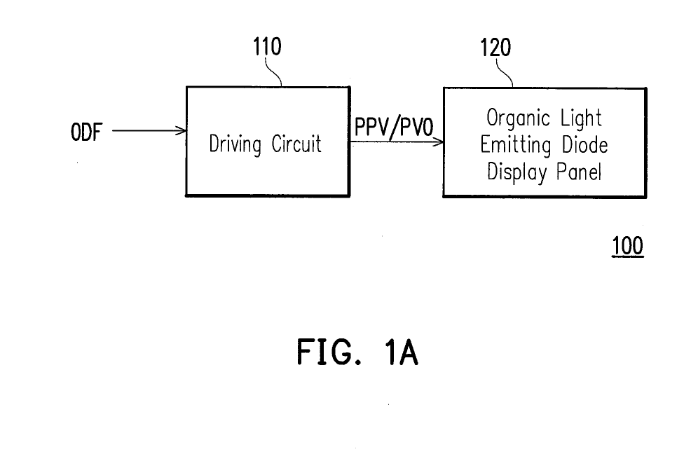

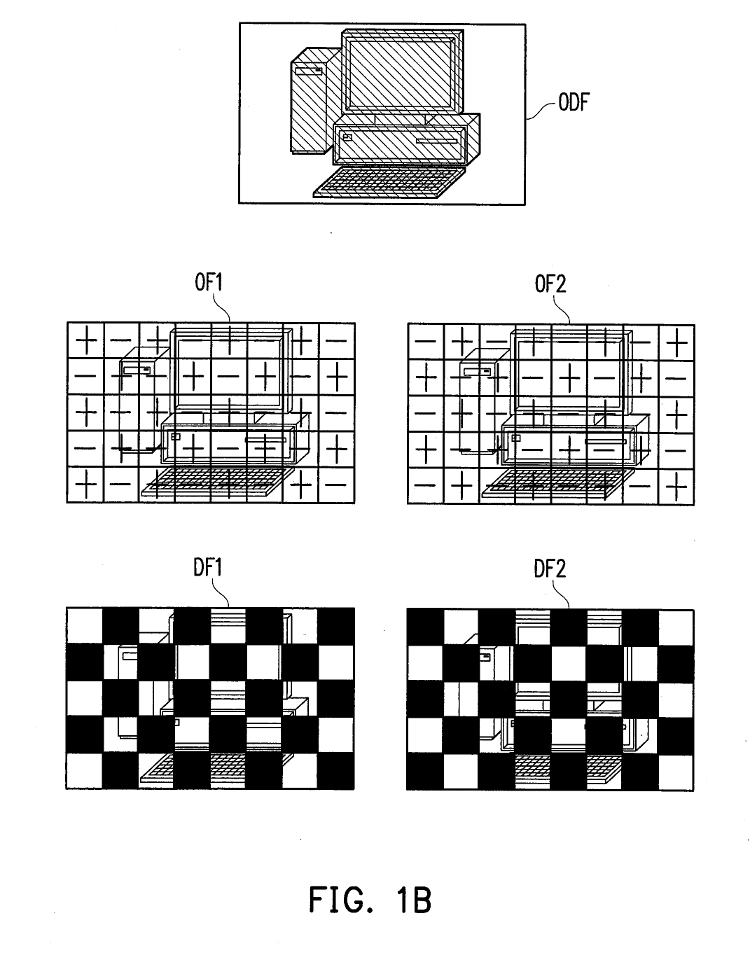

FIG. 1A is a schematic diagram of a system of an organic light emitting diode display according to an embodiment of the invention. Referring to FIG. 1A, in the embodiment, the organic light emitting diode display 100 includes a driving circuit 110 and an organic light emitting diode display panel 120. The driving circuit 110 is coupled to the organic light emitting diode display panel 120 and receives a primitive display frame ODF, and outputs a positive pixel voltage PPV and a zero gray-level pixel voltage PV0 to the organic light emitting diode display panel 120 according to the primitive display frame ODF. Wherein, the positive pixel voltage PPV is used to drive some pixels (not shown) of the organic light emitting diode display panel 120 to display a corresponding part of the primitive display frame ODF. The zero gray-level pixel voltage PV0 is used to control some pixels (not shown) of the organic light emitting diode display panel 120 to stop emitting light, that is equivalent to display in black, in order for the organic light emitting diode to rest and slow down the aging situation.

FIG. 1B is a schematic diagram of processing a frame according to an embodiment of the invention. Referring to FIG. 1A and FIG. 1B, in the embodiment, after receiving the primitive display frame ODF, the driving circuit 110 generates the first frame OF1 and the second frame OF2 corresponding to the primitive display frame ODF. The second frame OF2 is adjacent to the first frame OF1, namely, the first frame OF1 and the second frame OF2 are used to display continuously. Wherein, the driving circuit 110 generates the first frame OF1 and the second frame OF2 with a polarity inverting means, so that both the first frame OF1 and the second frame OF2 have a plurality of positive polarity data “+” and a plurality of negative polarity data “−”. Moreover, the first frame OF1 and the second frame OF2 are complementary in the data polarity, namely, the positions of the positive polarity data “+” of the first frame OF1 are identical to the positions of the negative polarity data “−” of the second frame OF2. Wherein, the dot inversion is used as the polarity inverting means as an example in the embodiment, but the column inversion and the row inversion may be applied in other embodiments. The embodiments of the invention should not be construed as limited herein.

Subsequently, for the corresponding part of the positive polarity data “+” of the first frame OF1 and the second frame OF2, the driving circuit 110 correspondingly outputs the positive pixel voltage PPV to the organic light emitting diode display panel 120, in order for some pixels (not shown) of the organic light emitting diode display panel 120 to display images corresponding to the first frame OF1 and the second frame OF2. For the corresponding part of the negative polarity data “−” of the first frame OF1 and the second frame OF2, the driving circuit 110 outputs the zero gray-level pixel voltage PV0 to the organic light emitting diode display panel 120, in order for some pixels (not shown) of the organic light emitting diode display panel 120 to stop emitting light, that is equivalent to display in black.

Since the first frame OF1 and the second frame OF2 are complementary in the data polarity, the synthesis of the image DF1 corresponding to the first frame OF1 and the image DF2 corresponding to the second frame OF2 displayed by the organic light emitting diode display panel 120 is the same as the primitive display frame ODF. Therefore, the display quality of an image is not affected, and the pixels (not shown) of the organic light emitting diode display panel 120 have time to rest.

In an embodiment, when the organic light emitting diode display 100 displays static frames, the received primitive display frames ODF are identical. Therefore, the driving circuit 110 may not generate the first frame OF1 and the second frame OF2 corresponding to the single primitive display frame ODF when the two primitive display frames ODF are identical, and the displayed image is not affected. On the other hand, when the organic light emitting diode display 100 displays dynamic frames, the received primitive display frames ODF are different. At the moment, the driving circuit 110 may generate the first frame OF1 and the second frame OF2 corresponding to the single primitive display frame ODF, in order for the organic light emitting diode display panel 120 to display images corresponding the primitive display frames ODF.

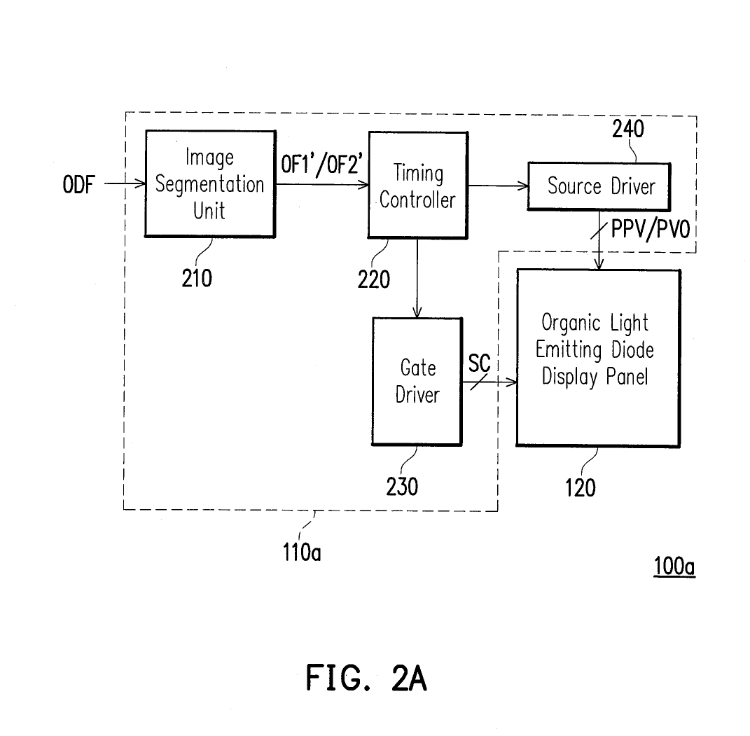

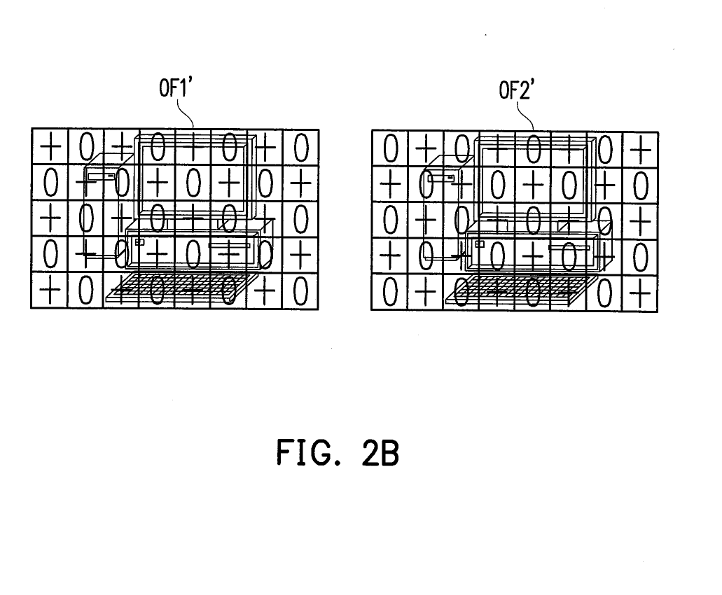

FIG. 2A is a schematic diagram of a system of a driving circuit according to an embodiment of the invention. FIG. 2B is a schematic diagram of processing a frame according to an embodiment of the invention. Referring to FIG. 1A, FIG. 1B, FIG. 2A and FIG. 2B, in the embodiment, the driving circuit 110a of the organic light emitting diode display 100a includes an image segmentation unit 210, a timing controller 220, a gate driver 230 and a source driver 240. The image segmentation unit 210 receives the primitive display frame ODF and generates the first frame OF1 and the second frame OF2 by the polarity inverting means. Subsequently, the image segmentation unit 210 outputs the adjusted first frame OF1′ and the adjusted second frame OF2′ after replacing the negative polarity data “−”in the first frame OF1 and the second frame OF2 by a zero gray-level data “0”.

The gate driver 230 and the source driver 240 are respectively coupled to the organic light emitting diode display panel 120. The timing controller 220 is coupled to the image segmentation unit 210, the gate driver 230 and the source driver 240, and receives the adjusted first frame OF1′ and the adjusted second frame OF2′. According to the adjusted first frame OF1′ and the adjusted second frame OF2′, the timing controller 220 controls the gate driver 230 to sequentially output a plurality of scan signals SC to the organic light emitting diode display panel 120, and the timing controller 220 controls the source driver 240 to output the zero gray-level pixel voltage PV0 to the organic light emitting diode display panel 120 corresponding to the zero gray-level data “0” and to output the positive pixel voltage PPV to the organic light emitting diode display panel 120 corresponding to the positive polarity data “+”, wherein the scan signals SC, the zero gray-level pixel voltage PV0 and the positive pixel voltage PPV are used to drive the organic light emitting diode display panel 120, in order for the organic light emitting diode display panel 120 to display images DF1 and DF2.

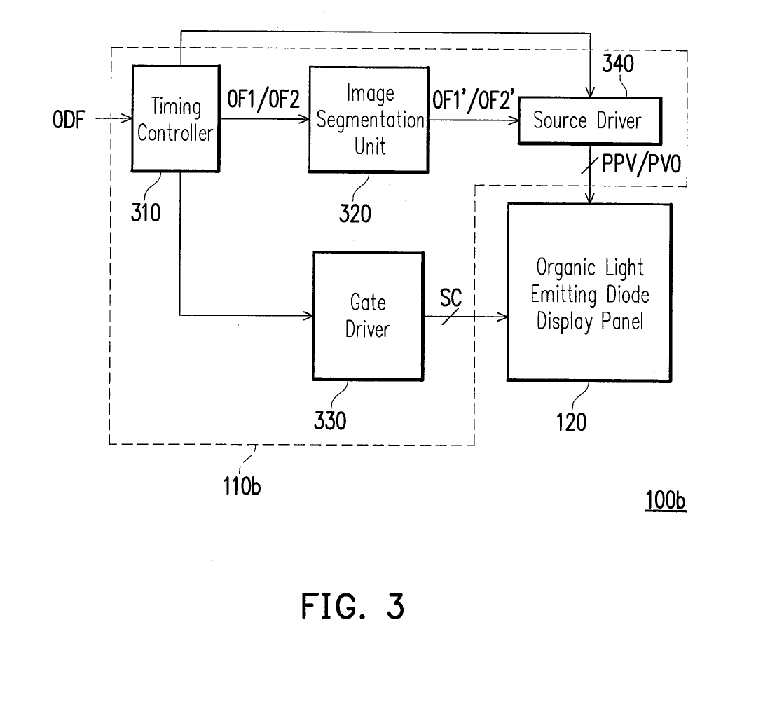

FIG. 3 is a schematic diagram of a system of a driving circuit according to another embodiment of the invention. Referring to FIG. 1A, FIG. 1B, FIG. 2B and FIG. 3, in the embodiment, the driving circuit 110b of the organic light emitting diode display 100b includes a timing controller 310, an image replacement unit 320, a gate driver 330 and a source driver 340. The timing controller 310 receives the primitive display frame ODF, and generates the first frame OF1 and the second frame OF2 by the polarity inverting means. The image replacement unit 320 is coupled to the timing controller 310, and receives the first frame OF1 and the second frame OF2, and outputs the adjusted first frame OF1′ and the adjusted second frame OF2′ after replacing the negative polarity data “−” of the first frame OF1 and the second frame OF2 by a zero gray-level data “0”.

The gate driver 330 is coupled to the timing controller 310 and the organic light emitting diode display panel 120, and is controlled by the timing controller 310 to sequentially output a plurality of scan signals SC to the organic light emitting diode display panel 120. The source driver 340 is coupled to the timing controller 310, the image replacement unit 320 and the organic light emitting diode display panel 120, and is controlled by the timing controller 310 to output the zero gray-level pixel voltage PV0 to the organic light emitting diode display panel 120 corresponding to the zero gray-level data “0” of the adjusted first frame OF1′ and the adjusted second frame OF2′ and to output the positive pixel voltage PPV to the organic light emitting diode display panel 120 corresponding to the positive polarity data “+” of the adjusted first frame OF1′ and the adjusted second frame OF2′.

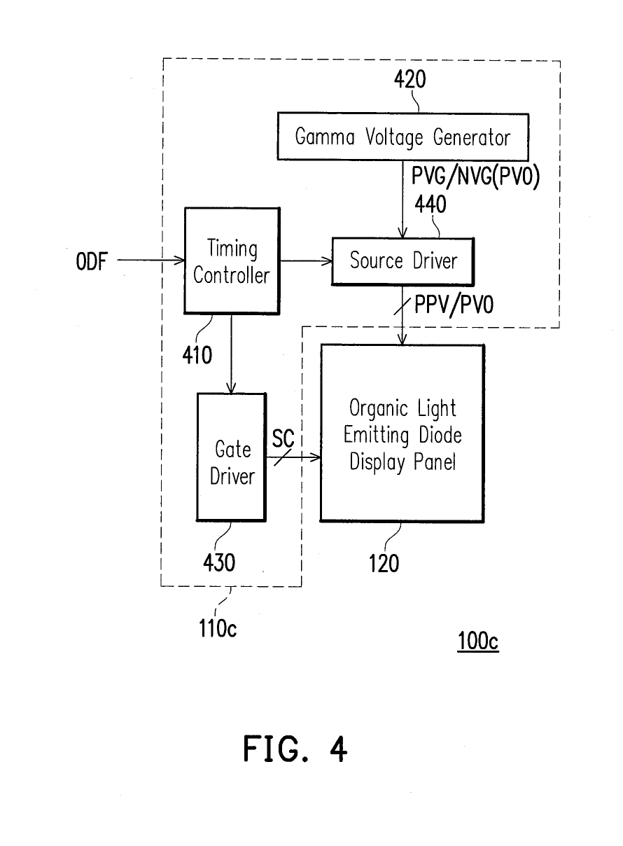

FIG. 4 is a schematic diagram of a system of a driving circuit according to yet another embodiment of the invention. Referring to FIG. 1A, FIG. 1B and FIG. 4, in the embodiment, the driving circuit 110c of the organic light emitting diode display 100c includes a timing controller 410, a gamma voltage generator 420, a gate driver 430 and a source driver 440. The timing controller 410 receives the primitive display frame ODF and generates the first frame OF1 and the second frame OF2 by the polarity inverting means. The gamma voltage generator 420 is used to generate a plurality of positive gamma voltages PVG and a plurality of negative gamma voltages NVG, wherein the negative gamma voltages NVG are set as to correspond to the zero gray-level pixel voltage PV0.

The gate driver 430 is coupled to the timing controller 410 and the organic light emitting diode display panel 120, and is controlled by the timing controller 410 to sequentially output a plurality of scan signals SC to the organic light emitting diode display panel 120. The source driver 440 is coupled to the timing controller 410, the gamma voltage generator 420 and the organic light emitting diode display panel 120.

The source driver 440 is controlled by the timing controller 410 to output one of the positive gamma voltages PVG outputted by the gamma voltage generator 420 as the positive pixel voltage PPV to the organic light emitting diode display panel 120 corresponding to the positive polarity data “+” of the first frame OF1 and the second frame OF2. Moreover, the source driver 440 is controlled by the timing controller 410 to output one of the negative gamma voltages NVG outputted by the gamma voltage generator 420 to the organic light emitting diode display panel 120 corresponding to the negative polarity data “−” of the first frame OF1 and the second frame OF2. Since the negative gamma voltages NVG are set as to correspond to the zero gray-level pixel voltage PV0, the source driver 440 is controlled by the timing controller 410 and the gamma voltage generator 440 to output the zero gray-level pixel voltage PV0 to the organic light emitting diode display panel 120 corresponding to the negative polarity data “−” of the first frame OF1 and the second frame OF2.

According to the above-mentioned, the embodiments of the invention use a driving circuit (such as a timing controller, a gate driver and a source driver) corresponding to a liquid crystal display to modify data of a received frame, or adjust positive gamma voltages or negative gamma voltages generated by a gamma voltage generator corresponding to driving method of the organic light emitting diode display panel 120, in order to use the driving circuit of the liquid crystal display to drive the organic light emitting diode display panel 120, and the development cost of the driving circuit is reduced. Since the embodiments of the invention utilize the driving circuit of the liquid crystal display to drive the organic light emitting diode display panel 120, all the applications of the liquid crystal display technology may be applied to the embodiments of the invention, so as to improve the display quality of the organic light emitting diode display (such as 100, 100a˜100c) in the embodiments of the invention.

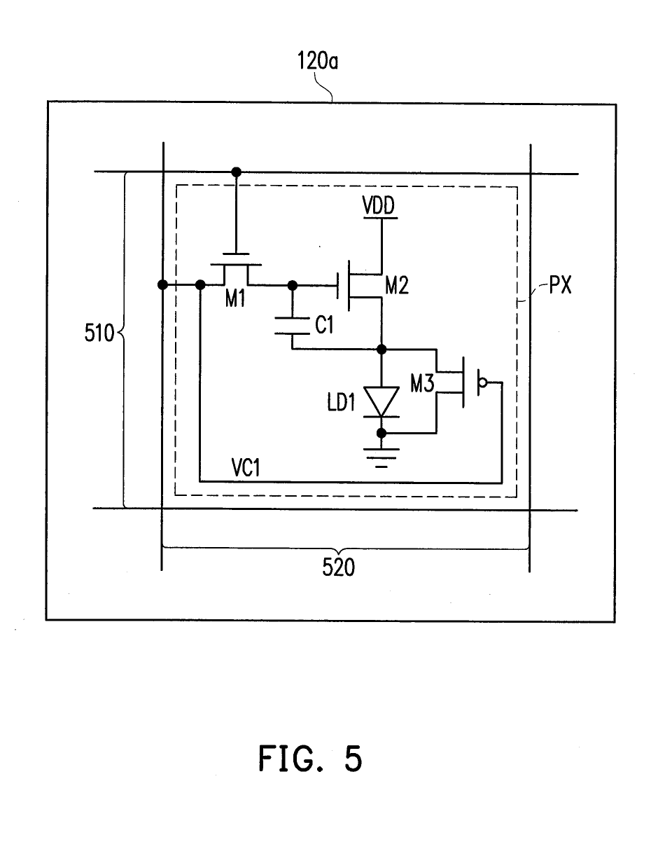

FIG. 5 is a schematic diagram of a circuit of an organic light emitting diode display panel according to an embodiment of the invention. Referring to FIG. 5, in the embodiment, the organic light emitting diode display panel 120a has a plurality of pixels (here a single pixel PX is shown as an example), a plurality of scan lines 510, a plurality of data lines 520, and each of the pixels (such as PX) is coupled to the corresponding scan line 510 and the corresponding data line 520, wherein the scan line 510 is used to receive the scan signals SC as shown in FIG. 2A, FIG. 3 and FIG. 4, the data line is used to receive the positive pixel voltage PPV and the zero gray-level pixel voltage PV0 as shown in FIG. 1A, FIG. 2A, FIG. 3 and FIG. 4.

In the embodiment, each of the pixels PX respectively includes transistors M1, M2, M3, a storage capacitor C1 and an organic light emitting diode LD1, wherein the transistors M1, M2 are N-type transistors and the transistor M3 is a P-type transistor. The drain of the transistor M1 (corresponding to the first drain) is coupled to the corresponding data line 520, and the gate of the transistor M1 (corresponding to the first gate) is coupled to the corresponding scan line 510. The drain of the transistor M2 (corresponding to the second drain) is coupled to the system voltage VDD, and the gate of the transistor M2 (corresponding to the second gate) is coupled to the source of the transistor M1 (corresponding to the first source). The storage capacitor C1 is coupled between the gate and the source (corresponding to the second source) of the transistor M2. The anode of the organic light emitting diode LD1 is coupled to the source of the transistor M2, and the cathode of the organic light emitting diode LD1 is coupled to the ground voltage. The source of the transistor M3 (corresponding to the third source) is coupled to the anode of the organic light emitting diode LD1, the drain of the transistor M3 (corresponding to the third drain) is coupled to the cathode of the organic light emitting diode LD1, and the gate of the transistor M3 is coupled to the corresponding data line 520, in order for the positive pixel voltage PPV and the zero gray-level pixel voltage PV0 received by the data line 520 to be used as a control signal VC1.

When the transistor M1 is turned on by the scan signals SC, the positive pixel voltage PPV or the zero gray-level pixel voltage PV0 received by the data line 520 is transmitted to the gate of the transistor M2, and the storage capacitor C1 stores the received positive pixel voltage PPV or the zero gray-level pixel voltage PV0, wherein the zero gray-level pixel voltage PV0 here is a low-voltage (such as the ground voltage), and the positive pixel voltage PPV is a voltage more than the threshold voltage of the transistor M2.

When the storage capacitor C1 stores the positive pixel voltage PPV, the transistor M2 is turned on by the positive pixel voltage PPV, and the conducting state of the transistor M2 is proportional to the voltage of the positive pixel voltage PPV. Here, the organic light emitting diode LD1 receives a current and thereby emits light, and displays a corresponding brightness (gray-level value) corresponding to the positive pixel voltage PPV. Moreover, the transistor M3 controlled by the positive pixel voltage PPV is turned off or the conducting state thereof is too low.

On the other hand, when the storage capacitor C1 stores the zero gray-level pixel voltage PV0, the transistor M2 controlled by the zero gray-level pixel voltage PV0 is turned off or the conducting state thereof is too low. Here, the organic light emitting diode LD1 is considered as no light emitting, or displaying in black. However, there is still a bias voltage between the anode and the cathode of the organic light emitting diode LD1. Moreover, the transistor M3 is turned on by the zero gray-level pixel voltage PV0, in order to reduce or eliminate the bias voltage across the organic light emitting diode LD1. Therefore, the aging process of the organic light emitting diode LD1 may slow down.

According to the above-mentioned embodiments (as shown in FIG. 1A, FIG. 1B, FIG. 2A, FIG. 2B, FIG. 3 and FIG. 4), the zero gray-level pixel voltage PV0 is outputted corresponding to the negative polarity data “−” of the first frame OF1 and the second frame OF2. Therefore, the transistor M3 of each of the pixels PX is turned on corresponding to the negative polarity data “−” of the first frame OF1 and the second frame OF2.

In the embodiment, the gate of the transistor M3 is coupled to the corresponding data line 520, and the positive pixel voltage PPV or the zero gray-level pixel voltage PV0 received by the data line 520 is used as the control signal VC1 of the transistor M3. However, in other embodiments, the gate of the transistor M3 may be coupled to an excess control circuit (not shown) or a signal process circuit (not shown) to receive the corresponding control signal VC1, and is turned on according to the corresponding control signal VC1 and corresponding to the negative polarity data “−” of the first frame OF1 and the second frame OF2. The transistor M3 may be realized as a P-type transistor or a N-type transistor to correspond to the enable level (that is a voltage level corresponding to the negative polarity data “−” of the first frame OF1 and the second frame OF2) of the control signal VC1. When the enable level is a high level, the transistor M3 may be realized as a N-type transistor. When the enable level is a low level, the transistor M3 may be realized as a P-type transistor.

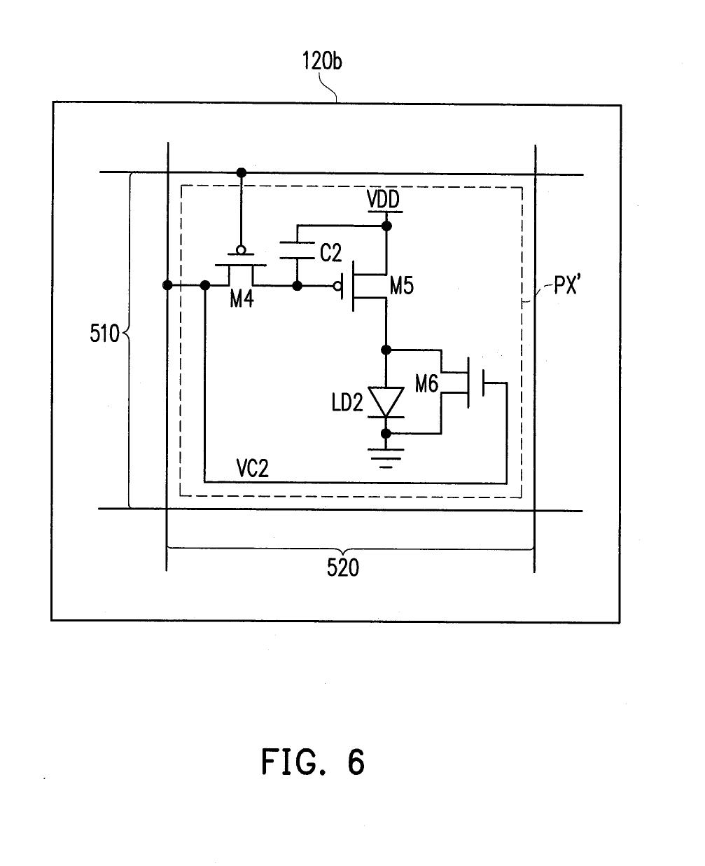

FIG. 6 is a schematic diagram of a circuit of an organic light emitting diode display panel according to another embodiment of the invention. Referring to FIG. 5 and FIG. 6, in the embodiment, the structure of the organic light emitting diode display panel 120b is similar to the structure of the organic light emitting diode display panel 120a, wherein a difference is in the circuit of a pixel PX′.

In the embodiment, each of the pixels PX′ respectively includes transistors M4, M5, M6, a storage capacitor C2 and an organic light emitting diode LD2, wherein the transistors M4 and M5 are P-type transistors and the transistor M6 is a N-type transistor. The source of the transistor M4 (corresponding to the first source) is coupled to the corresponding data line 520, and the gate of the transistor M4 (corresponding to the first gate) is coupled to the corresponding scan line 510. The source of the transistor M5 (corresponding to the second source) is coupled to the system voltage VDD, and the gate of the transistor M5 (corresponding to the second gate) is coupled to the drain of the transistor M4 (corresponding to the first drain). The storage capacitor C2 is coupled between the gate and the drain of the transistor M5 (corresponding to the second drain). The anode of the organic light emitting diode LD2 is coupled to the drain of the transistor M5, and the cathode of the organic light emitting diode LD2 is coupled to the ground voltage. The drain of the transistor M6 (corresponding to the third drain) is coupled to the anode of the organic light emitting diode LD2, the source of the transistor M6 (corresponding to the third source) is coupled to the cathode of the organic light emitting diode LD2, and the gate of the transistor M6 is coupled to the corresponding data line 520. The positive pixel voltage PPV and the zero gray-level pixel voltage PV0 received by the data line 520 are used as the control signal VC2.

When the transistor M4 is turned on by the scan signal SC, the positive pixel voltage PPV or the zero gray-level pixel voltage PV0 received by the data line 520 is transmitted to the gate of the transistor M5, and the storage capacitor C2 stores the received positive pixel voltage PPV or the zero gray-level pixel voltage PV0, wherein the zero gray-level pixel voltage PV0 here is a high-voltage (such as the system voltage), and the positive pixel voltage PPV is a voltage less than the threshold voltage of the transistor M5.

When the storage capacitor C2 stores the positive pixel voltage PPV, the transistor M5 is turned on by the positive pixel voltage PPV, and the conducting state of the transistor M5 is inversely proportional to the voltage of the positive pixel voltage PPV. Here, the organic light emitting diode LD2 receives a current and thereby emits light, and displays a corresponding brightness (gray-level value) corresponds to the positive pixel voltage PPV. Moreover, the transistor M6 is turned off or the conducting state thereof is too low controlled by the positive pixel voltage PPV.

On the other hand, when the storage capacitor C2 stores the zero gray-level pixel voltage PV0, the transistor M5 controlled by the zero gray-level pixel voltage PV0 is turned off or the conducting state thereof is too low. Here, the organic light emitting diode LD2 is considered as no light emitting, or displaying in black. However, there is still a bias voltage between the anode and the cathode of the organic light emitting diode LD2. Moreover, the transistor M6 is turned on by the zero gray-level pixel voltage PV0, in order to reduce or eliminate the bias voltage across the organic light emitting diode LD2. Therefore, the aging process of the organic light emitting diode LD2 may slow down.

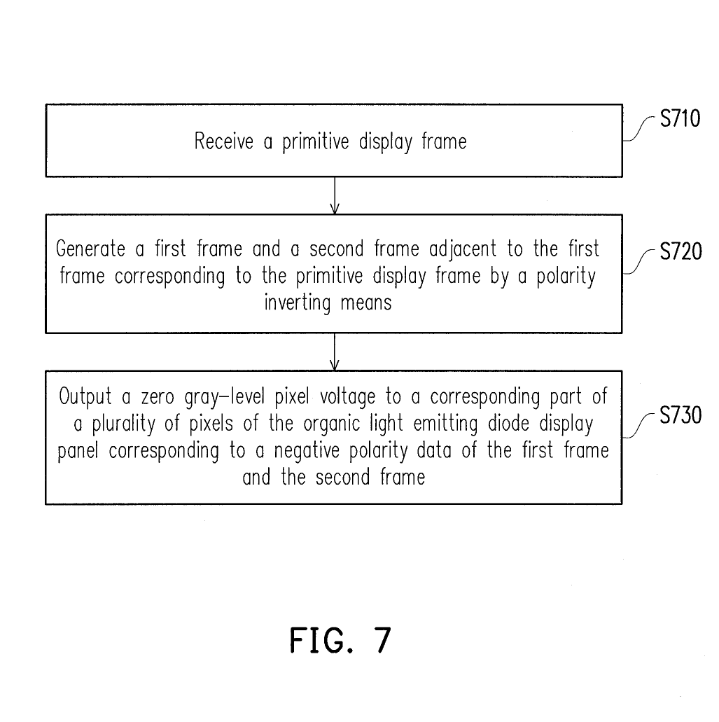

FIG. 7 is a flow diagram of an operating method of an organic light emitting diode display according to an embodiment of the invention. Referring to FIG. 7, in the embodiment, the operating method of the organic light emitting diode display includes the following steps. A primitive display frame is received (step S710). A first frame and a second frame corresponding to the primitive display frame are generated by a polarity inverting means, wherein the first frame is adjacent to the second frame (step S720). Then, a zero gray-level pixel voltage is outputted to a corresponding part of a plurality of pixels of the organic light emitting diode display panel corresponding to a negative polarity data of the first frame and the second frame (step S730). The description of the above steps may refer to the embodiments shown in FIG. 1A, FIG. 1B, FIG. 2A, FIG. 2B, FIG. 3 and FIG. 4, and thus detailed descriptions thereof is omitted.

In summary, in the organic light emitting display and the operating method thereof in the embodiments of the invention, a driving circuit generates a first frame and a second frame by a polarity inverting means according to a primitive display frame. Moreover, the driving circuit outputs a zero gray-level pixel voltage to the corresponding pixel of the organic light emitting diode display panel corresponding to the part of the negative polarity data of the first frame and the second frame, in order for the pixels of the organic light emitting diode display panel to stop emitting light, and thereby the organic light emitting diodes within the pixels is able to rest, so as to slow down the aging situation. Moreover, transistors may be coupled to the organic light emitting diode in parallel in the pixels, in order for the transistors to be turned on corresponding to the pixels receiving the zero gray-level pixel voltage (that is also corresponding to the negative polarity data), and thereby the bias voltage of the organic light emitting diode is reduced or eliminated. Furthermore, the embodiments of the invention modify the data of the frame received by the driving circuit or adjust the driving circuit, in order for the driving circuit of the liquid crystal display to be used to drive the organic light emitting diode display panel, and thereby the development cost of the driving circuit may be reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An organic light emitting diode display, comprising:
an organic light emitting diode display panel, having a plurality of pixels; and
a driving circuit, coupled to the organic light emitting diode display panel and receiving a primitive display frame, wherein the driving circuit generates a first frame and a second frame adjacent to the first frame corresponding to the primitive display frame by a polarity inverting means, and outputs a zero gray-level pixel voltage to the corresponding pixels of the organic light emitting diode display panel corresponding to a negative polarity data of the first frame and the second frame.

2. The organic light emitting diode display according to claim 1, wherein the driving circuit comprises:
an image segmentation unit, receiving the primitive display frame and generating the first frame and the second frame by the polarity inverting means, and outputting the adjusted first frame and the adjusted second frame after respectively replacing the negative polarity data of the first frame and the second frame by a zero gray-level data;
a source driver, coupled to the organic light emitting diode display panel; and
a timing controller, coupled to the image segmentation unit and the source driver and receiving the adjusted first frame and the adjusted second frame, wherein the timing controller controls the source driver to output the zero gray-level pixel voltage to the organic light emitting diode display panel corresponding to the zero gray-level data of the adjusted first frame and the adjusted second frame.

3. The organic light emitting diode display according to claim 1, wherein the driving circuit comprises:
a timing controller, receiving the primitive display frame and generating the first frame and the second frame by the polarity inverting means;
a image replacement unit, coupled to the timing controller and receiving the first frame and the second frame, and outputting the adjusted first frame and the adjusted second frame after replacing the negative polarity data of the first frame and the second frame by a zero gray-level data; and
a source driver, coupled to the timing controller, the image replacement unit and the organic light emitting diode display panel, and receiving the adjusted first frame and the adjusted second frame, wherein the source driver is controlled by the timing controller to output the zero gray-level pixel voltage to the organic light emitting diode display panel corresponding to the zero gray-level data of the adjusted first frame and the adjusted second frame.

4. The organic light emitting diode display according to claim 1, wherein the driving circuit comprises:
a timing controller, receiving the primitive display frame and generating the first frame and the second frame by the polarity inverting means;
a gamma voltage generator, used to generate a plurality of positive gamma voltages and a plurality of negative gamma voltages, wherein the negative gamma voltages are set as to correspond to the zero gray-level pixel voltage; and
a source driver, coupled to the timing controller, the gamma voltage generator and the organic light emitting diode display panel, wherein the source driver is controlled by the timing controller and the gamma voltage generator to output the zero gray-level pixel voltage to the organic light emitting diode display panel corresponding to the negative polarity data of the first frame and the second frame.

5. The organic light emitting diode display according to claim 1, wherein the organic light emitting diode display panel further has a plurality of scan lines and a plurality of data lines, and each of the pixels is respectively coupled to the corresponding scan line and the corresponding data line.

6. The organic light emitting diode display according to claim 5, wherein the pixels respectively comprises:
a first transistor, having a first source, a first drain and a first gate, wherein one of the first source and the first drain is coupled to the corresponding data line, and the first gate is coupled to the corresponding scan line;
a second transistor, having a second source, a second drain and a second gate, wherein one of the second source and the second drain is coupled to a system voltage, and the second gate is coupled to the other of the first source and the first drain;
a storage capacitor, coupled between the second gate and the second source;
an organic light emitting diode, wherein an anode of the organic light emitting diode is coupled to the other of the second source and the second drain, and a cathode of the organic light emitting diode is coupled to a ground voltage; and
a third transistor, having a third source, a third drain and a third gate, wherein the third source and the third drain are respectively coupled to the anode and the cathode of the organic light emitting diode, the third gate receives a control signal, and when each of the pixels corresponds to the negative polarity data, the third transistor of each of the pixels is turned on.

7. The organic light emitting diode display according to claim 6, wherein the control signal is a positive pixel voltage or the zero gray-level pixel voltage transmitted by the corresponding data line.

8. The organic light emitting diode display according to claim 7, wherein the first transistor and the second transistor are P-type transistors, and the third transistor is a N-type transistor.

9. The organic light emitting diode display according to claim 7, wherein the first transistor and the second transistor are N-type transistors, and the third transistor is a P-type transistor.

10. The organic light emitting diode display according to claim 1, wherein the first frame and the second frame are complementary in the data polarity.

11. An operating method of an organic light emitting display, comprising:
receiving a primitive display frame;
generating a first frame and a second frame adjacent to the first frame corresponding to the primitive display frame by a polarity inverting means; and
outputting a zero gray-level pixel voltage to a corresponding part of a plurality of pixels of an organic light emitting diode display panel corresponding to a negative polarity data of the first frame and the second frame.

12. The operating method of the organic light emitting display according to claim 11, wherein the steps of outputting the zero gray-level pixel voltage to the corresponding part of the pixels of the organic light emitting diode display panel corresponding to the negative polarity data of the first frame and the second frame, comprises:
outputting the adjusted first frame and the adjusted second frame after respectively replacing the negative polarity data of the first frame and the second frame by a zero gray-level data; and
outputting the zero gray-level pixel voltage to the organic light emitting diode display panel corresponding to the zero gray-level data of the adjusted first frame and the adjusted second frame.

13. The operating method of the organic light emitting display according to claim 11, wherein the steps of outputting the zero gray-level pixel voltage to the corresponding part of the pixels of the organic light emitting diode display panel corresponding to the negative polarity data of the first frame and the second frame, comprises:
providing a plurality of positive gamma voltages and a plurality of negative gamma voltages, wherein the negative gamma voltages are set as to correspond to the zero gray-level pixel voltage; and
outputting the zero gray-level pixel voltage to the organic light emitting diode display panel corresponding to the negative polarity data of the first frame and the second frame according to the negative gamma voltages.
